(19) United States
(12) Patent Application Publication
(10) Pub. No.: US 2020/0290220 A1
(43) Pub. Date: Sep. 17, 2020

(54) BOLT ACTION TOOL

(71) Applicant: William Robert Hodges, Garland, TX (US)

(72) Inventor: William Robert Hodges, Garland, TX (US)

(21) Appl. No.: 16/352,059

(22) Filed: Mar. 13, 2019

(51) Int. Cl. B26B 1/04; B26B 1/08

(52) U.S. Cl. CPC B26B 1/048; B26B 1/08

(57) ABSTRACT

A bolt action tool is disclosed in accordance with some embodiments. The bolt action tool may include a housing including a housing longitudinal body including a housing longitudinal bore. Further, the housing longitudinal body may include a first housing opening and second housing opening. Further, the housing longitudinal body may include at least one groove. Further, the bolt action tool may include a tool assembly including an assembly longitudinal body configured to be accommodated within the housing longitudinal bore, at least one tool attached to at least one assembly end of the assembly longitudinal body, and a bolt configured to be attached to the assembly longitudinal body. Further, the bolt action tool may include a biasing element cooperatively coupled to each of the tool assembly and the housing configured to maintain the tool assembly in at least one retracted position while the biasing element may be in a resting state.

### FIELD OF THE INVENTION

The present disclosure relates generally to the field of tools and hardware. More specifically, the present disclosure describes a bolt action tool.

### BACKGROUND OF THE INVENTION

Tools have been used by humans since the stone age for various tasks and purposes.

Hand tools are useful for daily tasks. Different types of tools which may be used for any kind of task to be performed exist. Some tools are versatile and may be used for various tasks, while some are function specific and limited to individual tasks.

However, tools may sometimes not be handy and portable enough to carry around comfortably. Further, many tools may need to be simply carried around without protective covers leading to potential injury.

Further, dispensing mechanisms associated with tools may not be versatile enough to allow carrying of multiple tools, and multiple types of tools simultaneously in a single housing.

Therefore, there is a need for an improved bolt action knife that may overcome one or more of the above-mentioned problems and/or limitations.

### SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, a bolt action tool is disclosed. The bolt action tool may include a housing including a housing longitudinal body including a housing longitudinal bore. Further, the housing longitudinal body may include a first housing opening and second housing opening. Further, the housing longitudinal bore may extend between the first housing opening and the second housing opening. Further, the housing longitudinal body may include at least one groove. Further, the at least one groove may include a longitudinal cut-away and at least one lateral cut-away. Further, the at least one lateral cut-away may be contiguous with the longitudinal cut-away. Further, the bolt action tool may include a tool assembly. Further, the tool assembly may include an assembly longitudinal body configured to be accommodated within the housing longitudinal bore. Further, the tool assembly may be configured to slide between at least one retracted position and at least one extended position within the longitudinal bore. Further, the tool assembly may include at least one tool attached to at least one assembly end of the assembly longitudinal body. Further, at least a portion of the at least one tool may be configured to extend out through one or more of the first housing opening and the second housing opening corresponding to the tool assembly being in the at least one extended position. Further, the at least one tool may be configured to be retracted into the housing longitudinal bore corresponding to the tool assembly being in the at least one retracted position. Further, the tool assembly may include a bolt configured to be attached to the assembly longitudinal body. Further, the bolt may include a protruding body extending from a first bolt end to a second bolt end. Further, the second bolt end may be configured to be attached to the assembly longitudinal body. Further, the protruding body may be configured to traverse through each of the longitude cut-away and the at least one lateral cut-away. Further, the bolt action tool may include a biasing element cooperatively coupled to each of the tool assembly and the housing. Further, the biasing element may be characterized by a resting state corresponding to an absence of a force acting upon the biasing element and an energized state corresponding to a presence of a force acting upon the biasing element. Further, the biasing element may be configured to maintain the tool assembly in the at least one retracted position while the biasing element may be in the resting state.

Further, according to some embodiments, a bolt action tool is disclosed. The bolt action tool may include a housing including a housing longitudinal body including a housing longitudinal bore. Further, the housing longitudinal body may include a first housing opening. Further, the housing longitudinal bore may be contiguous with the first housing opening. Further, the housing longitudinal body may include a groove including a longitudinal cut-away and a lateral cut-away. Further, the lateral cut-away may be contiguous with the longitudinal cut-away. Further, the bolt action tool may include a tool assembly. Further, the tool assembly may include an assembly longitudinal body configured to be accommodated within the housing longitudinal bore. Further, the tool assembly may be configured to slide between a retracted position and an extended position within the longitudinal bore. Further, the tool assembly may include a blade attached to an assembly end of the assembly longitudinal body. Further, at least a portion of the blade may be configured to extend out through the first housing opening corresponding to the tool assembly being in the extended position. Further, the blade may be configured to be retracted into the housing longitudinal bore corresponding to the tool assembly being in the retracted position. Further, the tool assembly may include a bolt configured to be attached to the assembly longitudinal body. Further, the bolt may include a protruding body extending from a first bolt end to a second bolt end. Further, the second bolt end may be configured to be attached to the assembly longitudinal body. Further, the protruding body may be configured to traverse through each of the longitude cut-away and the lateral cut-away. Further, the bolt action tool may include a biasing element cooperatively coupled to each of the tool assembly and the housing. Further, the biasing element may be characterized by a resting state corresponding to an absence of a force acting upon the biasing element and an energized state corresponding to a presence of a force acting upon the biasing element. Further, the biasing element may be configured to maintain the tool assembly in the retracted position while the biasing element may be in the resting state.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a side view of a bolt action tool consistent with various embodiments of the present disclosure.

FIG. 2 is a cut-away side view of a bolt action tool, in accordance with some embodiments.

FIG. 3 is a side view of a bolt action tool in an extended state, in accordance with an exemplary embodiment.

FIG. 4 is a cut-away side view of a bolt action tool in an extended state, in accordance with an exemplary embodiment.

FIG. 5 is a side view of a bolt action tool including a plurality of lateral cut-aways, in accordance with an exemplary embodiment.

FIG. 6 is a cut-away side view of a bolt action tool including a spring as a biasing element, in accordance with an exemplary embodiment.

FIG. 7 is a bolt of a bolt action tool, in accordance with an exemplary embodiment.

FIG. 8 is a side view of a bolt action tool including a housing end cap, in accordance with an exemplary embodiment.

FIG. 9 is a side view of a bolt action tool including a housing end cap configured to be removably attached to a first housing opening, in accordance with an exemplary embodiment.

FIG. 10 is a side view of a bolt action tool including a clip, in accordance with an exemplary embodiment.

FIG. 11 is a cut-away side view of a bolt action tool including a first tool and a second tool, in accordance with an exemplary embodiment.

FIG. 12 is a side view of a bolt action tool including a first tool and a second tool, in accordance with an exemplary embodiment.

FIG. 13 is a cut-away side view of a bolt action tool including a plurality of tools and a split hydraulic mechanism included in a biasing element, in accordance with an exemplary embodiment.

FIG. 14 is a cut-away side view of a bolt action tool including a first tool and a second tool when the first tool may be non-identical to the second tool, in accordance with an exemplary embodiment.

FIG. 15 is a cut-away side view of a bolt action tool including a biasing element and a second biasing element, in accordance with an exemplary embodiment.

FIG. 16 is a side view of a bolt action tool including a blade, in accordance with an exemplary embodiment.

FIG. 17 is a cut-away side view of a bolt action tool including a blade, in accordance with an exemplary embodiment.

FIG. 18 is a side view of a bolt action tool including a second longitudinal cut-away, in accordance with an exemplary embodiment.

FIG. 19 is an exploded view of a bolt action tool, in accordance with an exemplary embodiment.

FIG. 20 is a front view of a bolt action tool, in accordance with an exemplary embodiment.

FIG. 21 is a side view of a bolt action tool, in accordance with an exemplary embodiment.

FIG. 22 is a perspective close-up view of a bolt action tool, in accordance with an exemplary embodiment.

FIG. 23 is a side perspective close-up view of a bolt action tool, in accordance with an exemplary embodiment.

FIG. 24 is a front view of a bolt action tool, in accordance with an exemplary embodiment.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a bolt action tool, embodiments of the present disclosure are not limited to use only in this context.

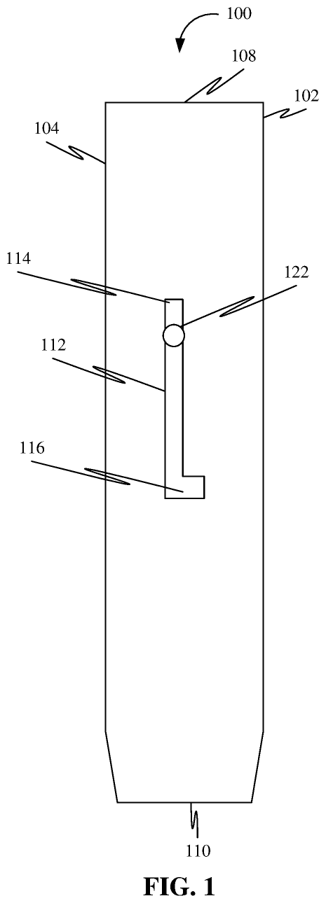

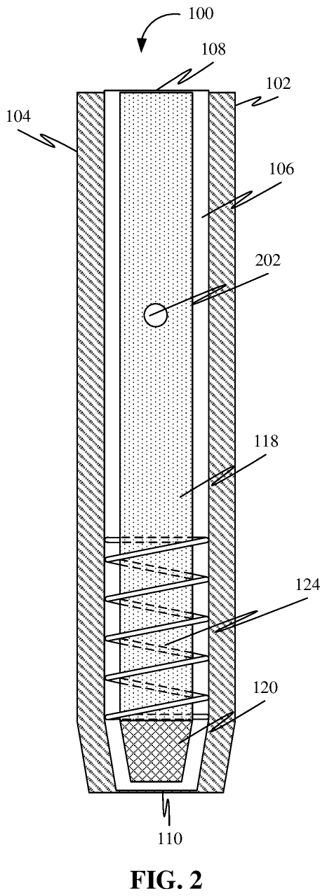

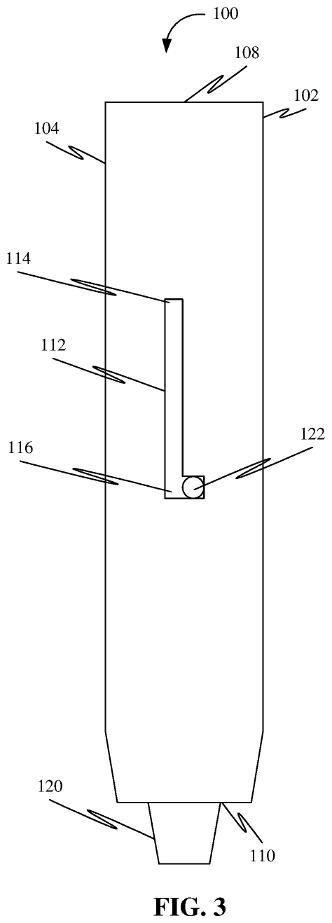

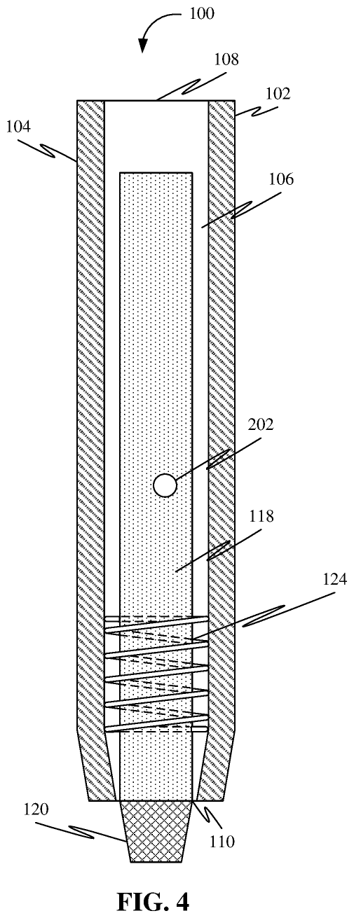

FIG. 1 is a side view of a bolt action tool 100, in accordance with an exemplary embodiment. Further, FIG. 2 is a cut-away side view of the bolt action tool 100, in accordance with an exemplary embodiment. The bolt action tool 100 may include a housing 102 including a housing longitudinal body 104 including a housing longitudinal bore 106. Further, the housing longitudinal body 104 may include a first housing opening 108 and second housing opening 110. Further, the housing longitudinal bore 106 may extend between the first housing opening 108 and the second housing opening 110. Further, the housing longitudinal body 104 may include at least one groove 112. Further, the at least one groove 112 may include a longitudinal cut-away 114 and at least one lateral cut-away 116. Further, the at least one lateral cut-away 116 may be contiguous with the longitudinal cut-away. Further, the bolt action tool 100 may include a tool assembly. Further, the tool assembly may include an assembly longitudinal body 118 configured to be accommodated within the housing longitudinal bore 106. Further, the tool assembly may be configured to slide between at least one retracted position (as shown in FIG. 2) and at least one extended position (as shown in FIG. 3, and FIG. 4) within the longitudinal bore.

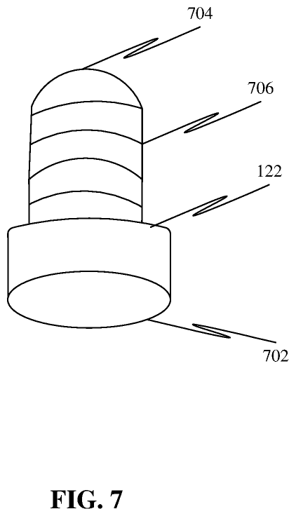

Further, the tool assembly may include at least one tool 120 attached to at least one assembly end of the assembly longitudinal body 118. Further, at least a portion of the at least one tool 120 may be configured to extend out through one or more of the first housing opening 108 and the second housing opening 110 corresponding to the tool assembly being in the at least one extended position. Further, the at least one tool 120 may be configured to be retracted into the housing longitudinal bore 106 corresponding to the tool assembly being in the at least one retracted position. Further, the tool assembly may include a bolt 122 configured to be attached to the assembly longitudinal body 118. Further, the bolt 122 may include a protruding body extending from a first bolt end 702 to a second bolt end 704 (as shown in FIG. 7). Further, the second bolt end 704 may be configured to be attached to the assembly longitudinal body 118. Further, the protruding body may be configured to traverse through each of the longitude cut-away and the at least one lateral cut-away.

In some embodiments, the at least one groove 112 may include a locking mechanism to lock the bolt 122 when the tool assembly in the at least one extended position.

Further, the bolt action tool 100 may include a biasing element 124 cooperatively coupled to each of the tool assembly and the housing 102. Further, the biasing element 124 may be characterized by a resting state corresponding to an absence of a force acting upon the biasing element 124 and an energized state corresponding to a presence of a force acting upon the biasing element 124. Further, the biasing element 124 may be configured to maintain the tool assembly in the at least one retracted position while the biasing element 124 may be in the resting state.

In some embodiments, the housing 102 may be shaped in a cylindrical manner. Further, in some embodiments, the housing may be shaped in a cuboidal manner, in the manner of an elongated triangular prism, or in any other shape.

Further, in an embodiment, the housing longitudinal bore 106 may be shaped in a cylindrical manner. Further, in some embodiments, the housing may be shaped in a cuboidal manner, in the manner of an elongated triangular prism, or in any other shape.

Further, in an embodiment, the housing longitudinal bore 106 may be shaped in a manner consistent with a shape of the housing 102.

Further, in an embodiment, the housing longitudinal bore 106 may be shaped in a manner different from the shape of the housing 102.

Further, the assembly longitudinal body 118 may be may be shaped in a manner consistent with a shape of the housing longitudinal bore 106 to be accommodated within the housing longitudinal bore 106.

Further, in an embodiment, a diameter, or width of the second housing opening 110 may be lesser than a diameter, or width of the first housing opening 108 due to the housing longitudinal body being tapered towards the second housing opening 110. Further, in an embodiment, the lesser diameter of the second housing opening 110 in comparison with the diameter, or width of the first housing opening 108 may keep the biasing element 124 in a fixed position, as shown in FIG. 2.

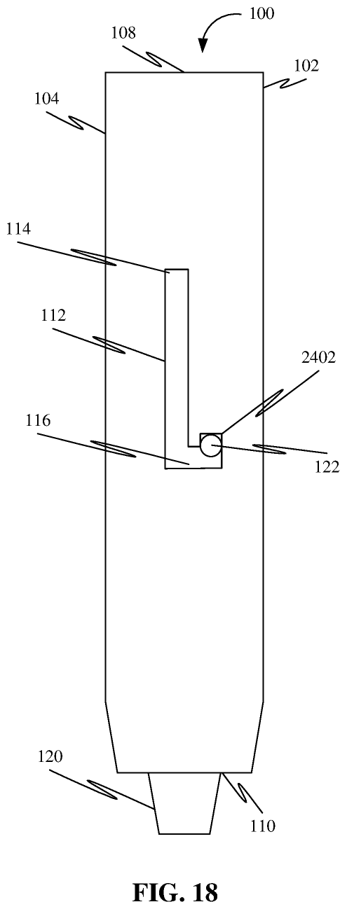

Further, as shown in FIG. 18, the at least one groove 112 may further include a second longitudinal cut-away 2402 located parallelly opposite to the longitudinal cut-away, and connected to the and at least one lateral cut-away 116. Further, the second longitudinal cut-away 2402 may be configured to lock the bolt 122 against a restoring action of the biasing element 124 thereby maintaining the tool assembly in the extended position. Further, in an embodiment, the second longitudinal cut-away 2402 may include a curled portion. Further, in an embodiment, the second longitudinal cut-away 2402 may be inclined at an angle with respect to the at least one lateral cut-away 116. Further, the bolt action tool 100, in an embodiment, the may be made up of materials such as (but not limited to) Iron, Copper, Lead, Molybdenum, Nickel, Tin, Zinc, Titanium, Silver, Gold, Platinum, and/or alloys etc.

Further, in an embodiment, the tool 120 may be made up of materials such as (but not limited to) Iron, Copper, Lead, Molybdenum, Nickel, Tin, Zinc, Titanium, Silver, Gold, Platinum, Diamond, and/or alloys etc.

In some embodiments, the at least one tool 120 may include a blade. Further, in some embodiments, the tool 120 may include any type of hand tool, including, but not limited to a wrench, pliers, a cutter, a file, a screwdriver, a vise, a clamp, a hand drill, and so on.

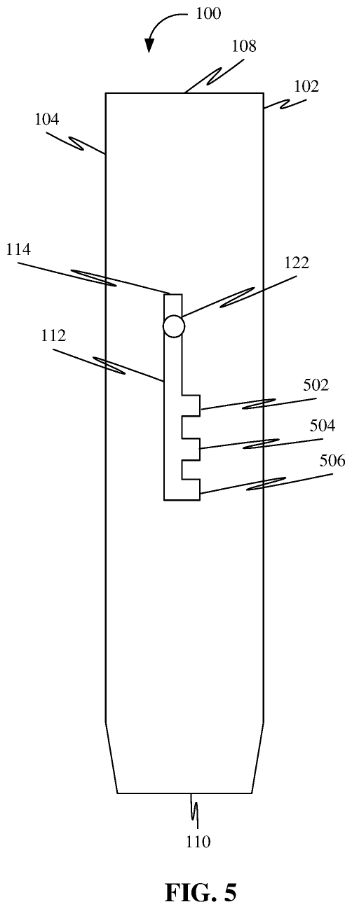

In some embodiments, as shown in FIG. 1, the at least one groove 112 may include a single groove. Further, the at least one lateral cut-away 116 may include a single lateral cut-away. Further, in some embodiments, as shown in FIG. 5, the at least one lateral cut-away 116 may include a plurality of lateral cut-aways, including lateral cut-away 502, lateral cut-away 504, and lateral cut-away 506. Further, each of the plurality of lateral cut-aways may correspond to the tool assembly being in the at least one extended position.

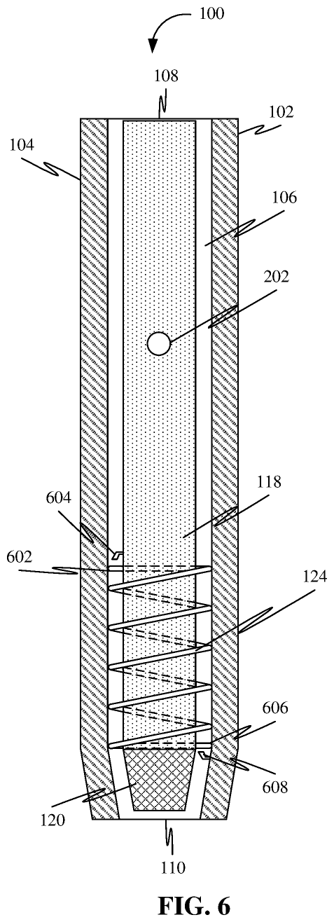

In some embodiments, as shown in FIG. 6, the biasing element 124 may include a spring. Further, in an embodiment, the biasing element 124 may include a hydraulic mechanism cooperatively coupled to each of the tool assembly and the housing 102. Further, the hydraulic mechanism may be characterized by a resting state corresponding to an absence of a force acting upon the hydraulic mechanism when the tool assembly may be in the at least one retracted position. Further, the hydraulic mechanism may be in an energized state corresponding to a presence of a force acting upon the hydraulic element when the bolt 122 may be in the at least one lateral cut-away, and the tool assembly may be in the at least one extended position. Further, the hydraulic assembly may be configured to maintain the tool assembly in the at least one retracted position while the biasing element 124 may be in the resting state.

In some embodiments, the spring may be disposed around the tool assembly. Further, as shown in FIG. 6, first spring end 602 of the spring (biasing member) may abut an assembly notch 604 and a second spring end 606 of the spring may abut a housing notch 608.

In some embodiments, the spring may be disposed around a proximal portion of the tool assembly.

In some embodiments, the protruding body of the bolt 122 may be characterized by a protrusion cross-sectional profile matched with the at least one groove 112.

In some embodiments, the second bolt end 704 may be configured to be removably attached to a bolt attachment location 202 on the assembly longitudinal body 118.

In some embodiments, the second bolt end 704 may include external threads 706 (as shown in FIG. 7) configured to mate with internal threads comprised in the bolt attachment location on the assembly longitudinal body 118.

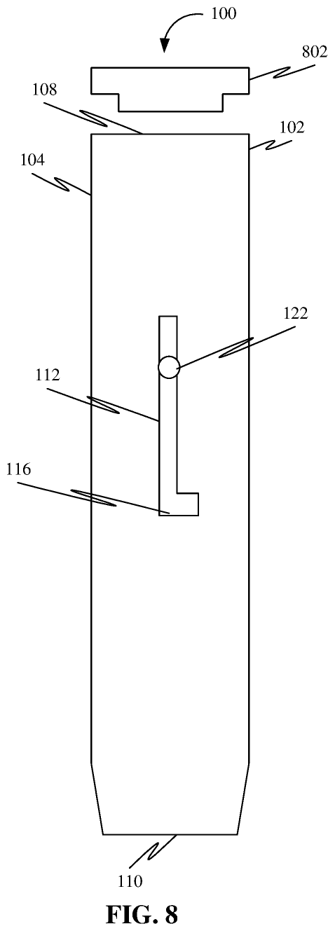

In some embodiments, the housing 102 may include a housing end cap 802 (as shown in FIG. 8) configured to be removably attached to one or more of the first housing opening 108 and the second housing opening 110, such as the first housing opening 108.

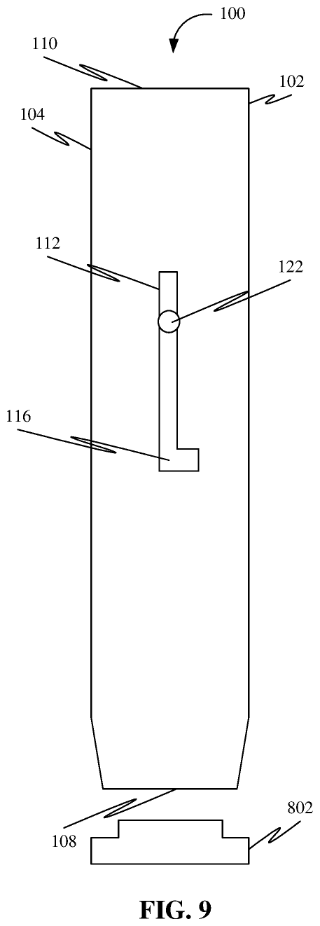

In some embodiments, the housing end cap 802 may be configured to be removably attached to the first housing opening 108. Further, at least a portion of the at least one tool 120 may be configured to extend out through the first housing opening 108, as shown in FIG. 9.

In some embodiments, the housing end cap 802 may include external threads configured to mate with internal threads comprised in an interior wall corresponding to the first housing opening 108.

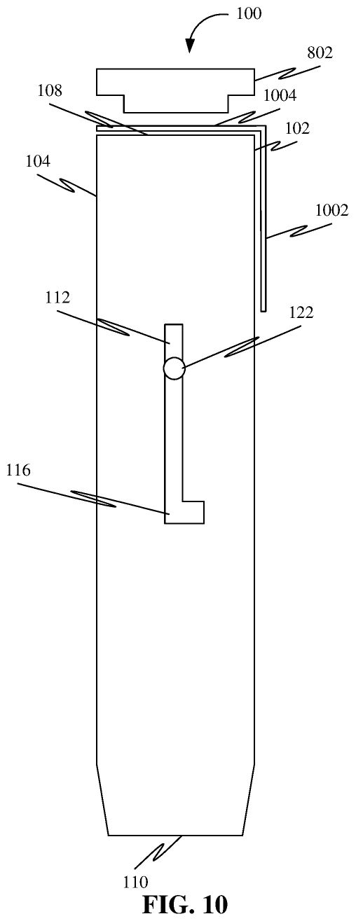

In some embodiments, the bolt action tool 100 may further include a clip 1002 configured to be attached to the housing 102, as shown in FIG. 10. Further, the clip 1002 may include a clip opening 1004 configured to receive at least a portion of the housing end cap 802.

In some embodiments, the at least one tool 120 may be removably attached to the tool assembly.

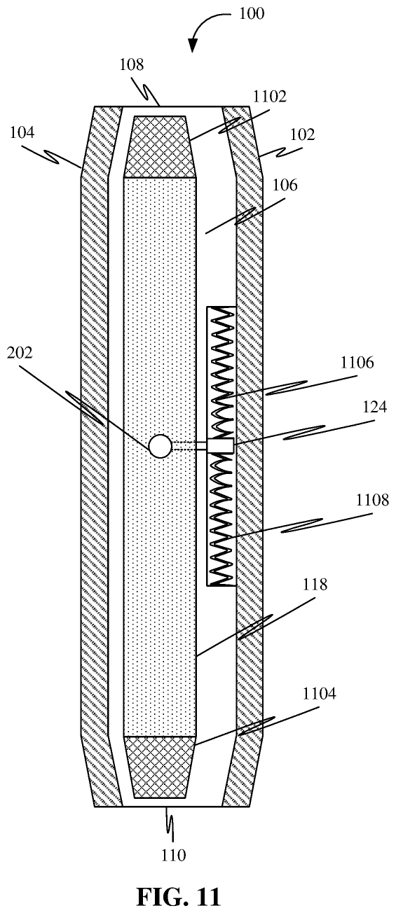

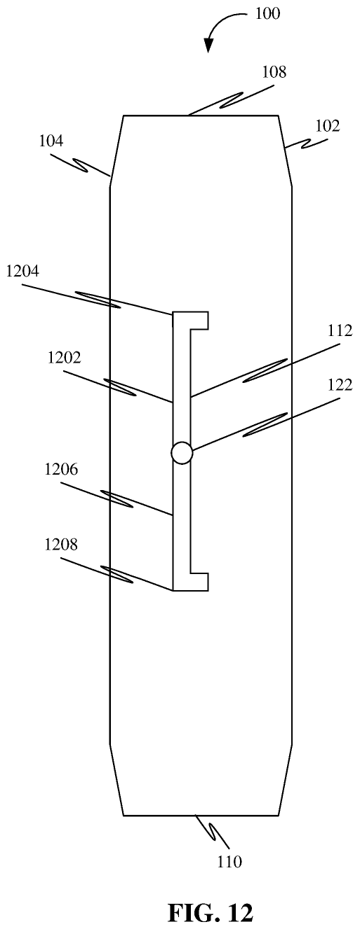

In some embodiments, the at least one tool 120 may include a plurality of tools. Further, a first tool 1102 of the plurality of tools may be attached to a first assembly end of the assembly longitudinal body 118 and a second tool 1104 of the plurality of tools may be attached to a second assembly end of the assembly longitudinal body 118, as shown in FIG. 11. Further, biasing element 124 may be placed in a central location inside the housing longitudinal bore 106 to maintain the first tool 1102 and the second tool 1104 in the at least one retracted position while the biasing element 124 is in the resting state. Further, the biasing element 124 may include a split spring mechanism. Further, the split spring mechanism may include a first spring 1106 oriented towards the first assembly end, and a second spring 1108 oriented towards the second assembly end. Further, the at least one groove 112 may include a first longitudinal cut-away 1202, and a first lateral cut-away 1204 oriented towards the first assembly end, and a second longitudinal cut-away 1206, and a second lateral cut-away 1208 oriented towards the second assembly end, as shown in FIG. 12. Further, the movement of the bolt 122 towards the first lateral cut-away 1204 may engage the first spring 1106 and cause the biasing element 124 to reach the energized state. Further, the movement of the bolt 122 towards the second lateral cut-away 1208 may engage the second spring 1108 and cause the biasing element 124 to reach the energized state. Further, when the biasing element 124 may be in the energized state, the biasing element 124 may tend to bring the first tool 1102, and the second tool 1104 to the retracted state.

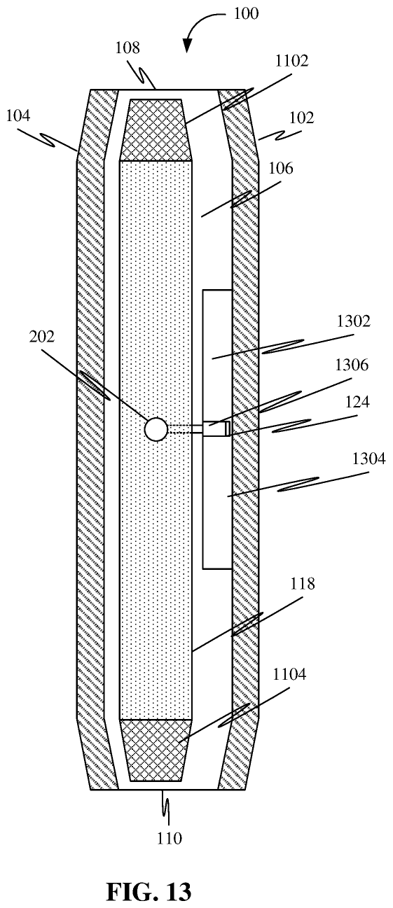

Further, in an embodiment, as shown in FIG. 13, the biasing element 124 may include a split hydraulic mechanism. Further, the split hydraulic mechanism may include a first hydraulic 1302 including a first isolated fluid column oriented towards the first assembly end, a second hydraulic 1304 including a second isolated fluid column oriented towards the second assembly end, and a piston 1306. Further, the at least one groove 112 may include a first longitudinal cut-away 1202, and a first lateral cut-away 1204 oriented towards the first assembly end, and a second longitudinal cut-away 1206, and a second lateral cut-away 1208 oriented towards the second assembly end, as shown in FIG. 12. Further, the movement of the bolt 122 towards the first lateral cut-away 1204 may engage the first hydraulic 1302 by compressing the first isolated fluid column through the piston 1306 and cause the biasing element 124 to reach the energized state. Further, the movement of the bolt 122 towards the second lateral cut-away 1208 may engage the second hydraulic 1304 through the piston 1306 compressing the second isolated fluid column and cause the biasing element 124 to reach the energized state. Further, when the biasing element 124 may be in the energized state, the biasing element 124 may tend to bring the first tool 1102, and the second tool 1104 to the retracted state.

In some embodiments, as shown in FIG. 11, and FIG. 13, the first tool 1102 may be identical to the second tool 1104.

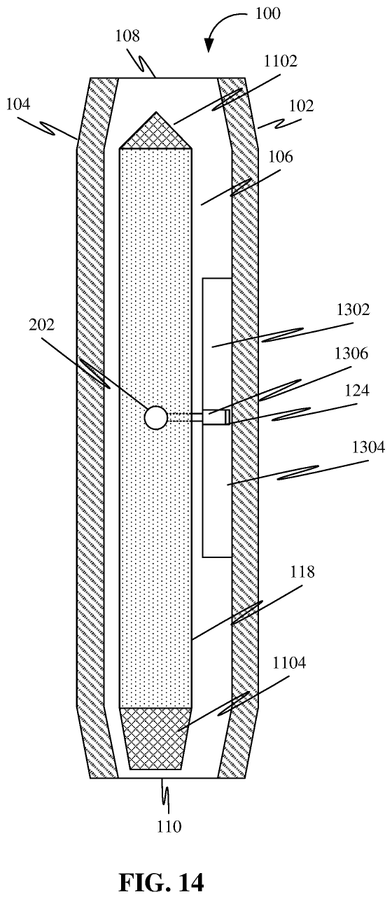

In some embodiments, as shown in FIG. 14, the first tool 1102 may be non-identical to the second tool 1104.

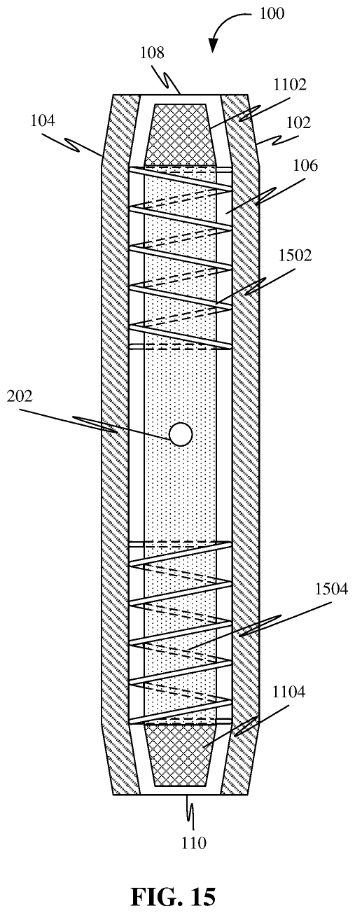

In some embodiments, the biasing element 124 may include a plurality of biasing elements corresponding to the plurality of tools. Further, as shown in FIG. 15, a first biasing element 1502 may be configured to maintain the first tool 1102 in the retracted position while in a resting state corresponding to the first biasing element 1502. Further, a second biasing element 1504 may be configured to maintain the second tool 1104 in the retracted position while in a resting state corresponding to the second biasing element 1504.

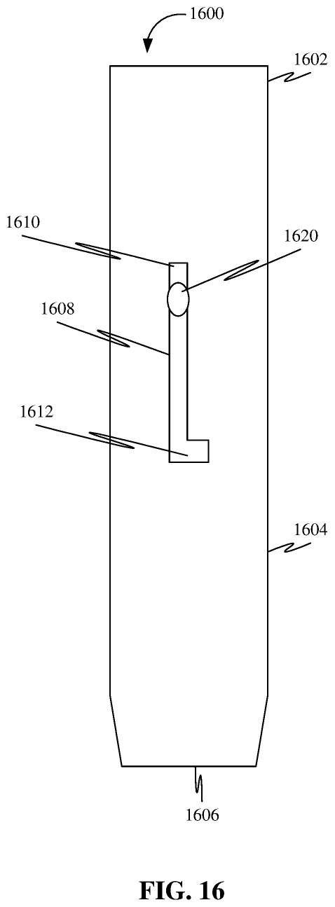

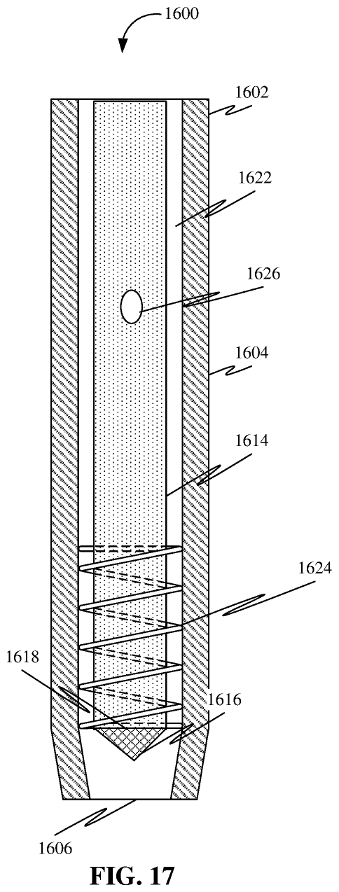

FIG. 16 is a side view of a bolt action tool 1600, according to an exemplary embodiment. Further, FIG. 17 is a cut-away side view of the bolt action tool 1600, according to an exemplary embodiment.

The bolt action tool 1600 may include a housing 1602 including a housing longitudinal body 1604 including a housing longitudinal bore 1622 (as shown in FIG. 17). Further, the housing longitudinal body 1604 may include a first housing opening 1606. Further, the housing longitudinal bore 1622 may be contiguous with the first housing opening 1606. Further, the housing longitudinal body 1604 may include a groove 1608 including a longitudinal cut-away 1610 and a lateral cut-away 1612. Further, the lateral cut-away 1612 may be contiguous with the longitudinal cut-away 1610. Further, the bolt action tool 1600 may include a tool assembly. Further, the tool assembly may include an assembly longitudinal body 1614 configured to be accommodated within the housing longitudinal bore 1622. Further, the tool assembly may be configured to slide between a retracted position and an extended position within the housing longitudinal bore 1622. Further, the tool assembly may include a blade 1616 attached to an assembly end 1618 of the assembly longitudinal body 1614. Further, at least a portion of the blade 1616 may be configured to extend out through the first housing opening 1606 corresponding to the tool assembly being in the extended position. Further, the blade 1616 may be configured to be retracted into the housing longitudinal bore 1622 corresponding to the tool assembly being in the retracted position. Further, the tool assembly may include a bolt 1620 configured to be attached to the assembly longitudinal body 1614. Further, the bolt 1620 may include a protruding body extending from a first bolt end to a second bolt end. Further, the second bolt end may be configured to be attached to the assembly longitudinal body 1614. In some embodiments, the second bolt end may be configured to be removably attached to a bolt attachment location 1626 on the assembly longitudinal body 1614.

Further, the protruding body may be configured to traverse through each of the longitude cut-away and the lateral cut-away 1612. Further, the bolt action tool 1600 may include a biasing element 1624 cooperatively coupled to each of the tool assembly and the housing. Further, the biasing element 1624 may be characterized by a resting state corresponding to an absence of a force acting upon the biasing element 1624 and an energized state corresponding to a presence of a force acting upon the biasing element 1624. Further, the biasing element 1624 may be configured to maintain the tool assembly in the retracted position while the biasing element 1624 may be in the resting state.

In some embodiments, the lateral cut-away 1612 may include a curled portion configured to lock the bolt 1620 against a restoring action of the biasing element 1624 thereby maintaining the tool assembly in the extended position.

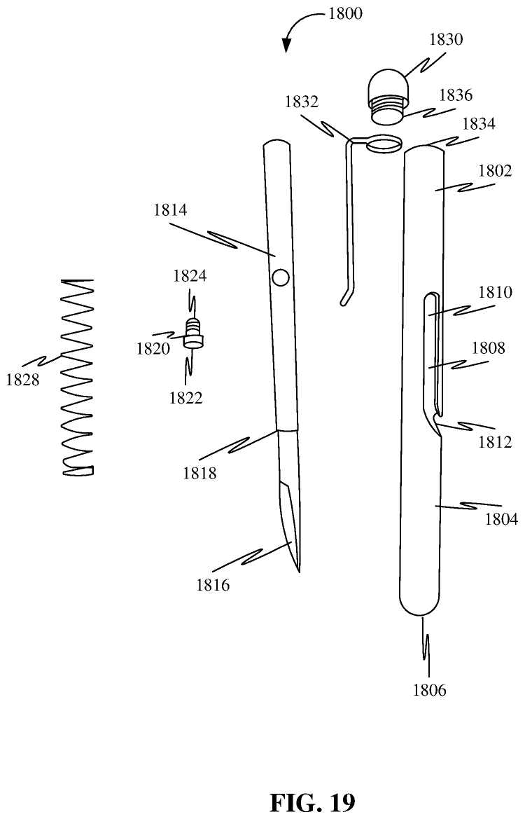

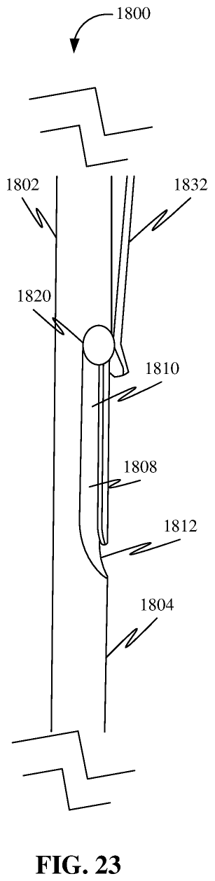

FIG. 19 is an exploded view of an exemplary bolt action tool 1800, according to some embodiments. The bolt action tool may include a housing 1802 including a housing longitudinal body 1804 including a housing longitudinal bore (not shown). Further, the housing longitudinal body 1804 may include a first housing opening 1806. Further, the housing longitudinal bore may be contiguous with the first housing opening 1806. Further, the housing longitudinal body 1804 may include a groove 1808 including a longitudinal cut-away 1810 and a lateral cut-away 1812. Further, the lateral cut-away 1812 may be contiguous with the longitudinal cut-away 1810. Further, the bolt action tool may include a tool assembly. Further, the tool assembly may include an assembly longitudinal body 1814 configured to be accommodated within the housing longitudinal bore. Further, the tool assembly may be configured to slide between a retracted position and an extended position within the housing longitudinal bore. Further, the tool assembly may include a blade 1816 attached to an assembly end 1818 of the assembly longitudinal body 1814. Further, at least a portion of the blade 1816 may be configured to extend out through the first housing opening 1806 corresponding to the tool assembly being in the extended position, as shown in FIG. 23. Further, the blade 1816 may be configured to be retracted into the housing longitudinal bore corresponding to the tool assembly being in the retracted position. Further, the tool assembly may include a bolt 1820 configured to be attached to the assembly longitudinal body 1814. Further, the bolt 1820 may include a protruding body extending from a first bolt end 1822 to a second bolt end 1824. Further, the second bolt end 1824 may be configured to be attached to the assembly longitudinal body 1814. Further, the protruding body may be configured to traverse through each of the longitude cut-away and the lateral cut-away 1812. Further, the bolt action tool may include a biasing element 1828 cooperatively coupled to each of the tool assembly and the housing. Further, the biasing element 1828 may be characterized by a resting state corresponding to an absence of a force acting upon the biasing element 1828 and an energized state corresponding to a presence of a force acting upon the biasing element 1828. Further, the biasing element 1828 may be configured to maintain the tool assembly in the retracted position while the biasing element 1828 may be in the resting state.

In some embodiments, the lateral cut-away 1812 may include a curled portion configured to lock the bolt 1820 against a restoring action of the biasing element 1828 thereby maintaining the tool assembly in the extended position.

In some embodiments, the housing 1802 may include a housing end cap 1830 configured to be removably attached to one or more of the first housing opening and a second housing opening 1834 of the housing 1802.

In some embodiments, the housing end cap 1830 may include external threads 1836 configured to mate with internal threads comprised in an interior wall corresponding to the second housing opening 1834.

In some embodiments, the bolt action tool 1800 may further include a clip 1832 configured to be attached to the housing 1802. Further, the clip 1832 may include a clip opening configured to receive at least a portion of the housing end cap 1830.

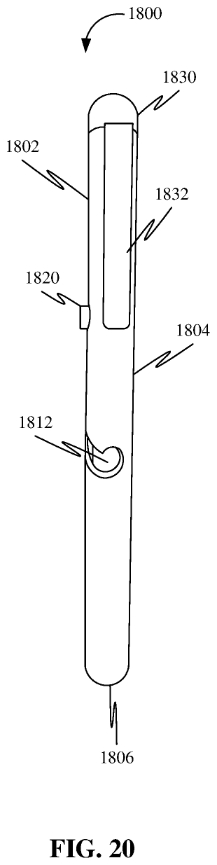

FIG. 20 is a front view of the bolt action tool 1800, in accordance with some embodiments.

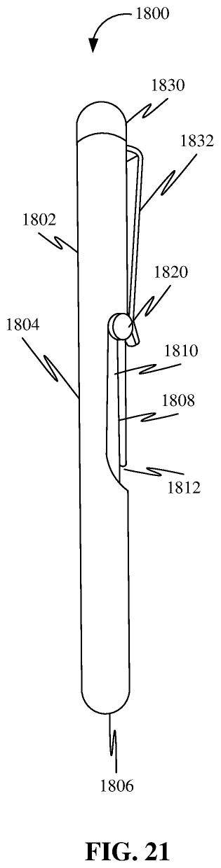

FIG. 21 is a side view of the bolt action tool 1800, in accordance with some embodiments.

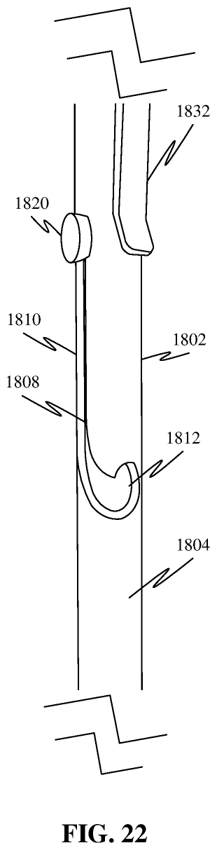

FIG. 22 is a perspective close-up view of the bolt action tool 1800, in accordance with some embodiments.

FIG. 23 is a side perspective close-up view of the bolt action tool 1800, in accordance with some embodiments.

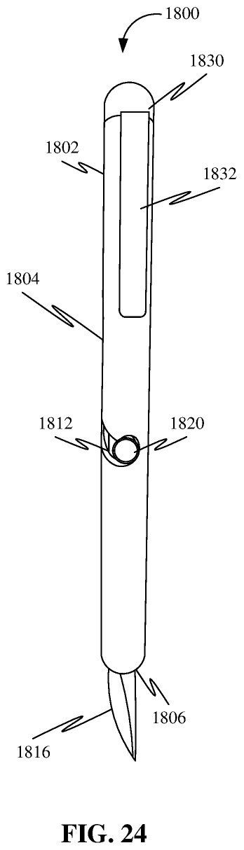

FIG. 24 is a front view of the bolt action tool 1800 with the tool in the extended state, in accordance with some embodiments.

What is claimed is:

1. A bolt action tool comprising:
a housing comprising a housing longitudinal body comprising a housing longitudinal bore, wherein the housing longitudinal body comprises a first housing opening and second housing opening, wherein the housing longitudinal bore extends between the first housing opening and the second housing opening, wherein the housing longitudinal body comprises at least one groove, wherein the at least one groove comprises a longitudinal cut-away and at least one lateral cut-away, wherein the at least one lateral cut-away is contiguous with the longitudinal cut-away;
a tool assembly comprising:
an assembly longitudinal body configured to be accommodated within the housing longitudinal bore, wherein the tool assembly is configured to slide between at least one retracted position and at least one extended position within the longitudinal bore;
at least one tool attached to at least one assembly end of the assembly longitudinal body, wherein at least a portion of the at least one tool is configured to extend out through at least one of the first housing opening and the second housing opening corresponding to the tool assembly being in the at least one extended position, wherein the at least one tool is further configured to be retracted into the housing longitudinal bore corresponding to the tool assembly being in the at least one retracted position; and
a bolt configured to be attached to the assembly longitudinal body, wherein the bolt comprises a protruding body extending from a first bolt end to a second bolt end, wherein the second bolt end is configured to be attached to the assembly longitudinal body, wherein the protruding body is configured to traverse through each of the longitude cut-away and the at least one lateral cut-away;
a biasing element cooperatively coupled to each of the tool assembly and the housing, wherein the biasing element is characterized by a resting state corresponding to an absence of a force acting upon the biasing element and an energized state corresponding to a presence of a force acting upon the biasing element, wherein the biasing element is configured to maintain the tool assembly in the at least one retracted position while the biasing element is in the resting state.

2. The bolt action tool of claim 1, wherein the at least one tool comprises a blade.

3. The bolt action tool of claim 1, wherein the at least one groove comprises a single groove, wherein the at least one lateral cut-away comprises a single lateral cut-away.

4. The bolt action tool of claim 1, wherein the biasing element comprises a spring.

5. The bolt action of claim 4, wherein the spring is disposed around the tool assembly, wherein a first spring end of the spring abuts an assembly notch and a second spring end of the spring abuts a housing notch.

6. The bolt action tool of claim 5, wherein the spring is disposed around a proximal portion of the tool assembly.

7. The bolt action tool of claim 1, wherein the protruding body is characterized by a protrusion cross-sectional profile matched with the at least one groove.

8. The bolt action tool of claim 1, wherein the second bolt end is configured to be removably attached to a bolt attachment location on the assembly longitudinal body.

9. The bolt action tool of claim 8, wherein the second bolt end comprises external threads configured to mate with internal threads comprised in the bolt attachment location on the assembly longitudinal body.

10. The bolt action tool of claim 1, wherein the housing further comprises a housing end cap configured to be removably attached to at least one of the first housing opening and the second housing opening.

11. The bolt action tool of claim 10, wherein the housing end cap is configured to be removably attached to the first housing opening, wherein at least a portion of the at least one tool is configured to extend out through the first housing opening.

12. The bolt action tool of claim 11, wherein the housing end cap comprises external threads configured to mate with internal threads comprised in an interior wall corresponding to the first housing opening.

13. The bolt action tool of claim 11 further comprising a clip configured to be attached to the housing, wherein the clip comprises a clip opening configured to receive at least a portion of the housing end cap.

14. The bolt action tool of claim 1, wherein the at least one tool is removably attached to the tool assembly.

15. The bolt action tool of claim 1, wherein the at least one tool comprises of a plurality of tools, wherein a first tool of the plurality of tools is attached to a first assembly end of the assembly longitudinal body and a second tool of the plurality of tools is attached to a second assembly end of the assembly longitudinal body.

16. The bolt action tool of claim 15, wherein first tool is identical to the second tool.

17. The bolt action tool of claim 15, wherein first tool is non-identical to the second tool.

18. The bolt action tool of claim 15, wherein the biasing element comprises a plurality of biasing elements corresponding to the plurality of tools, wherein a first biasing element is configured to maintain the first tool in the retracted position while in a resting state corresponding to the first biasing element, wherein a second biasing element is configured to maintain the second tool in the retracted position while in a resting state corresponding to the second biasing element.

19. A bolt action tool comprising:
a housing comprising a housing longitudinal body comprising a housing longitudinal bore, wherein the housing longitudinal body comprises a first housing opening, wherein the housing longitudinal bore is contiguous with the first housing opening, wherein the housing longitudinal body comprises a groove comprising a longitudinal cut-away and a lateral cut-away, wherein the lateral cut-away is contiguous with the longitudinal cut-away;
a tool assembly comprising:
an assembly longitudinal body configured to be accommodated within the housing longitudinal bore, wherein the tool assembly is configured to slide between a retracted position and an extended position within the longitudinal bore;
a blade attached to an assembly end of the assembly longitudinal body, wherein at least a portion of the blade is configured to extend out through the first housing opening corresponding to the tool assembly being in the extended position, wherein the blade is further configured to be retracted into the housing longitudinal bore corresponding to the tool assembly being in the retracted position; and
a bolt configured to be attached to the assembly longitudinal body, wherein the bolt comprises a protruding body extending from a first bolt end to a second bolt end, wherein the second bolt end is configured to be attached to the assembly longitudinal body, wherein the protruding body is configured to traverse through each of the longitude cut-away and the lateral cut-away;
a biasing element cooperatively coupled to each of the tool assembly and the housing, wherein the biasing element is characterized by a resting state corresponding to an absence of a force acting upon the biasing element and an energized state corresponding to a presence of a force acting upon the biasing element, wherein the biasing element is configured to maintain the tool assembly in the retracted position while the biasing element is in the resting state.

20. The bolt action tool of claim 19, wherein the lateral cut-away comprises a curled portion configured to lock the bolt against a restoring action of the biasing element thereby maintaining the tool assembly in the extended position.
